(19) United States
(12) Patent Application Publication
(10) Pub. No.: US 2017/0103367 A1
(43) Pub. Date: Apr. 13, 2017

(54) Systems and Methods for Checking Purchase Eligibility Criteria on Products, Before Purchasing the Products

(71) Applicant: MASTERCARD INTERNATIONAL INCORPORATED, Purchase, NY (US)

(72) Inventor: Wayne A. Borgmeyer, Wentzville, MO (US)

(21) Appl. No.: 14/877,430

(22) Filed: Oct. 7, 2015

(51) Int. Cl. G06Q 10/10; G06Q 20/36

(52) U.S. Cl. CPC G06Q 10/1053; G06Q 20/36

(57) ABSTRACT

Systems and methods are provided for use in complying with purchase eligibility criteria defined by an authority. One exemplary method generally includes obtaining, by a computing device, a product identifier where the product identifier is indicative of at least the product and/or a product category associated with the product, and transmitting, by the computing device, at least the product identifier to the authority. The method also generally includes receiving, by the computing device, a purchase eligibility criteria associated with the product identifier and displaying, at the computing device, a valid indicator, when the product satisfies the purchase eligibility criteria, thereby permitting the consumer to purchase the product with confidence that said purchase complies with the eligibility criteria defined by the authority.

### FIELD

The present disclosure generally relates to systems and methods for checking the status of purchase eligibility criteria on products, set by certain policy authorities, before checkout and, in particular, to systems and methods for permitting consumers to use portable communication devices to gather identifying information for such products, before checkout, and compare the information to the corresponding purchase eligibility criteria as set by the policy authorities.

### BACKGROUND

This section provides background information related to the present disclosure which is not necessarily prior art.

Consumers use payment accounts to purchase various different products (e.g., good and services, etc.). The products may be purchased in physical stores or through websites, or through other web-based store fronts, associated with one or more merchants. In some cases, consumers use payment cards or accounts to purchase the products, where the payment cards or accounts are limited to use with (or can only be used for) certain types of purchases. Separately, many consumers have portable communication devices such as mobile phones, tablets, laptops, etc. through which they can access up-to-date information, over networks, for various different products.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in checking purchase eligibility criteria for products prior to finalizing purchases for the products;

FIG. 2 is a block diagram of a computing device that may be used in the exemplary system of FIG. 1;

FIG. 3 is a flowchart describing an exemplary method, that may be implemented in connection with the system of FIG. 1, for obtaining validation for a product and/or of purchase eligibility criteria for the product, on a communication device by a consumer, from a purchase eligibility provider;

FIG. 4 is an exemplary interface that may be displayed to a consumer at a communication device, in connection with the system of FIG. 1 and/or the method of FIG. 3, for obtaining purchase eligibility criteria for a product; and

FIG. 5 is an exemplary interface that may be displayed to the consumer in connection with the interface of FIG. 4, displaying the obtained purchase eligibility criteria for the product on the communication device.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers purchase products (e.g., goods and/or services, etc.) for a variety of reasons. When the consumers travel, for example, for business reasons (e.g., as employees, etc.), the consumers may purchase products that are used for personal reasons (e.g., lodging, meals, etc.) and products that are used in the furtherance of the consumers' business reasons for the travel, etc. Often, employers of the consumers (broadly, policy authorities) establish purchase eligibility criteria (e.g., purchase controls, permissions, limitations, requirements, etc.) for the consumers' spending when traveling indicating, for example, what is and what is not approved by the employers as business expenses for reimbursement. More broadly, policy authorities (e.g., the employers, other entities or persons, etc.) may impose such criteria on the purchases of others (e.g., the employees; other subordinates to the authorities such as those in principle-agent relationships, parent-child relationships, etc.), whereby particular rules associated with the criteria indicate what products qualify for reimbursement, credit, approval, etc. by the policy authorities (i.e., what products/purchases involve “eligible” transactions), and what products do not qualify.

Uniquely, the systems and methods herein permit consumers, associated with various policy authorities, to determine whether purchases of certain products are eligible transactions or not, based on various purchase eligibility criteria imposed by the policy authorities, prior to actually purchasing the products, checking out, and/or finalizing the purchases. In particular, the consumers may use communication devices, such as a smartphones, tablets, or the like, to enter identifying information about the products (or categories or features of the products) to determine whether purchases of the products are eligible transactions in view of whatever criteria are imposed by the corresponding policy authorities and/or are associated with the consumers (or with payment accounts to be used by the consumers in purchasing the products). In this manner, the consumers can make informed decisions about their purchases and the corresponding products, based on the available purchase eligibility criteria and/or corresponding determinations as to whether or not the products (and their corresponding purchases) are qualified (or eligible) in view of the policy authorities' corresponding purchase eligibility criteria.

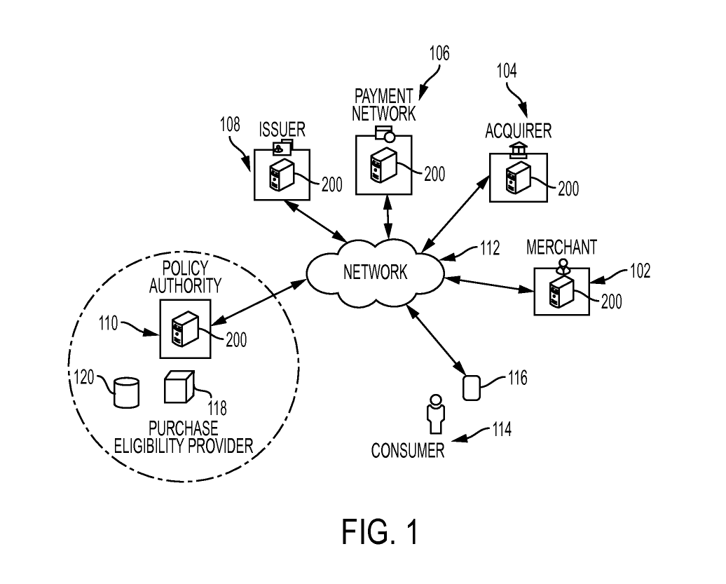

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, a relation of an policy authority to a consumer, retrieval and/or storage of purchase eligibility criteria, etc.

The system 100 generally includes a merchant 102, an acquirer 104, a payment network 106, an issuer 108, and a policy authority 110, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which may provide interconnection between one or more of the merchant 102, the payment network 106, the policy authority 110 and a consumer 114 (or a consumer's communication device 116), etc.

The merchant 102 is generally associated with products (e.g., goods and/or services, etc.), which are offered for sale and are sold to consumers in the system 100, including consumer 114. The merchant 102 may offer the products for sale in physical locations or through websites, or through other web-based store fronts, as desired.

The policy authority 110 is related to the consumer 114, in such a manner that the policy authority 110 provides funding, benefits, and/or reimbursement, etc. to the consumer 114 for transactions by the consumer 114, when the transactions conform to particular criteria (e.g., particular purchase controls, permissions, limitations, requirements, etc.) imposed by the policy authority 110 (broadly, when the transactions and associated products are eligible transactions/products). The policy authority 110 may include, without limitation, an employer, a manager, a governmental agency, a financial institution, a parent, or any other entity or person, etc. that has some form of purchase control over the consumer 114. As indicated above, the criteria (also referred to as purchase eligibility criteria herein) imposed by the policy authority 110 define which transactions, and specifically, which products are eligible for funding, approval, benefits, and/or reimbursement by the policy authority 110. The criteria may relate, for example, to product types, product categories, merchant types, etc., or may be specific to particular products (e.g., Product A is eligible but Product B is ineligible, etc.). Further detail related to such criteria, as referred to herein, is described below.

The consumer 114 is able to fund transactions with the merchant 102 for one or more products, via different payment options. In one embodiment, the consumer 114 funds transactions with a payment account, which may be associated with the consumer 114, the policy authority 110, or both. Specifically, for example, when the payment account is associated with the consumer 114, following a transaction, the consumer 114 may seek reimbursement for the transaction to the payment account from the policy authority 110. For example, when the consumer 114 is an employee and the transaction involves travel for work on behalf of the policy authority 110 (e.g., as an employer of the consumer 114, etc.), the consumer 114 may seek to get reimbursed for the transaction from the policy authority 110 (assuming the transaction satisfies at least one of the policy authority's purchase eligibility criteria such as those involving travel expenses (e.g., hotel, airfare, etc.), etc.). Conversely, when the payment account is associated with the policy authority 110, the policy authority 110 may fund (or approve) all eligible transactions by the consumer 114 to the payment account but seek reimbursement from the consumer 114 for any transactions to the payment account that are ineligible (again, according to the policy authority's purchase eligibility criteria).

In any case, in connection with a payment account transaction by the consumer 114 at the merchant 102, for the purchase of a product, the transaction is generally initiated by presentation of a payment device (associated with the corresponding payment account) by the consumer 114 to the merchant 102. In turn, the merchant 102 submits an authorization request to the acquirer 104 for the transaction. The authorization request may include, for example, a payment account number (PAN), an amount of the transaction, a merchant ID, a merchant category code (MCC), and/or additional information as desired and/or as necessary to process the transaction, etc. (broadly, transaction data) The acquirer 104 then communicates the authorization request to the issuer 108, through the payment network 106, such as, for example, through MasterCard®, VISA®, Discover®, American Express®, etc., to determine (by the issuer 108) whether the payment account (associated with the payment device) is in good standing and whether there is sufficient credit and/or funds to complete the transaction. If the issuer 108 accepts the transaction, a reply authorizing the transaction is provided back to the acquirer 104 and the merchant 102, thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108) (through further communications therebetween). If the issuer 108 declines the transaction, however, a reply declining the transaction is provided back to the merchant 102, thereby permitting the merchant 102 to terminate the transaction.

Transaction data is generated, collected, and stored as part of the above interactions among the merchant 102, the acquirer 104, the payment network 106, the issuer 108, and the consumer 114. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100 as used or needed. As indicated above, the transaction data may include, for example, payment account numbers, amounts of the transactions, merchant IDs, merchant category codes (MCCs), dates/times of the transactions, products purchased and related descriptions or identifiers, etc.

In various exemplary embodiments, the consumers (e.g., consumer 114, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein.

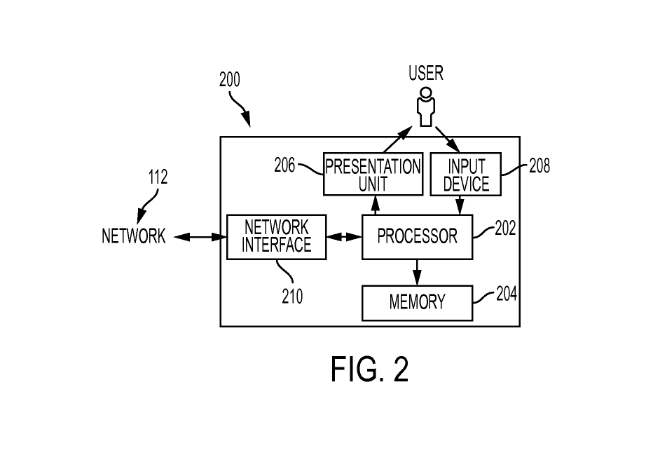

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, the issuer 108, and the policy authority 110 are illustrated as including, or being implemented in, computing device 200, coupled to the network 112. Further, the computing devices 200 associated with these parts of the system 100, for example, may include a single computing device, or multiple computing devices located in close proximity or distributed over a geographic region, again so long as the computing devices are specifically configured to function as described herein. In addition, the communication device 116, which is associated with consumer 114, can also be considered a computing device consistent with computing device 200 for purposes of the description herein. In particular, in this exemplary embodiment, the communication device 116 is a portable communication device, such as, for example, a smartphone, a tablet, a laptop, etc.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, purchase eligibility criteria, product identifiers, consumer profiles, authority profiles, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., valid product indicators, invalid product indicators, etc.), visually, for example, to a user of the computing device 200 such as the consumer 114 in the system 100, etc. It should be further appreciated that various interfaces (e.g., as defined by web-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices. The computing device 200 also includes an input device 208 that receives inputs from the user (i.e., user inputs) such as, for example, product identifiers, etc. The input device 208 may include a single input device or multiple input devices. The input device 208 is coupled to (and in communication with) the processor 202 and may include, for example, one or more of a keyboard, a pointing device, a mouse, a stylus, a barcode scanner, a QR code scanner, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

Referring again to FIG. 1, the policy authority 110 is associated with (as indicated by the dotted lines) a purchase eligibility provider 118, which is specifically configured, by computer executable instructions, to perform one or more of the operations described herein. While the purchase eligibility provider 118 is illustrated as a standalone entity in the system 100, it should be appreciated that the purchase eligibility provider 118 may be incorporated with, or integrated with, the policy authority 110. In addition, it should also be appreciated that the purchase eligibility provider 118 may be associated with, or incorporated with, other parts of the system, 100 in other embodiments, including, for example, the payment network 106, the issuer 108, the communication device 116, etc. Also, in FIG. 1 the purchase eligibility provider 118 is illustrated as associated with only the policy authority 110. In various other embodiments, however, the purchase eligibility provider 118 is associated with multiple policy authorities (e.g., multiple employers, etc.), whereby the purchase eligibility provider 118 may operate, as described herein, for more than a single policy authority (e.g., for more than just policy authority 110, etc.).

The purchase eligibility provider 118 includes a memory (e.g., memory 204), which includes a data structure 120 populated with purchase eligibility criteria, organized by (and/or based on) the policy authority 110 and/or the consumer 114.

The purchase eligibility criteria included in the data structure 120 may relate to the consumer 114. For example, different consumers may be associated with different responsibilities and/or tasks within a company, such that different purchase eligibility criteria may be associated with the different consumers. The data structure 120 thus may include criteria organized by particular employees (broadly, consumers), or by type of employees (or position within a company). For example, particular employee A may be subject to criteria A, while particular employee B may be subject to different criteria B. Likewise, employee type A (e.g., a manager, a salesperson, etc.) may be subject to criteria A, while employee type B (e.g., an executive, etc.) may be subject to different criteria B.

In addition, the purchase eligibility criteria included in the data structure 120 may also (or alternatively) relate to particular products. For example, the criteria may be product, or product category, specific so that certain products and/or categories of product may be eligible for transactions by the consumer 114, while other products and/or categories of products are ineligible. For example, the criteria may include, or be specific to, certain product identifiers such as Unique Product Codes (UPCs), Stock Keeping Units (SKUs), or similar product IDs, etc. With that said, the data structure 120 may include the criteria in any suitable form. Other purchase eligibility criteria may include, for example, expense account policies for sales representatives, policies related to donations and gifts for government lobbyists, policies related to purchase of supplies and materials for corporate purchasers, etc.

In the system 100, the purchase eligibility criteria is generally specific to the policy authority 110. When the purchase eligibility provider 118 is associated with multiple policy authorities, however, in certain other embodiments, the criteria may be generic to multiple of the policy authorities, or specific to particular ones of the multiple policy authorities (and/or consumers associated therewith), and included (and organized) in data structure 120 accordingly.

The purchase eligibility criteria in the data structure 120, as defined by the policy authority 110, may also limit amounts spent by the consumer 114 on particular types of products over a time period. For instance, the consumer 114 may be limited to the amount spent at restaurants each day, as in a “per diem” arrangement. The amount spent over the time period is then tracked by part of the system 100, such as the consumer's communication device 116 or the purchase eligibility provider 118, etc. When the consumer 114 makes an inquiry based on a “per diem” limited account, the system 100 takes the tracked amount, as already incurred, into account when determining the eligibility of a subsequent purchase transaction. In connection with these purchase eligibility criteria, the consumer 114 may be required to input the price of the subsequent product, to the communication device 116, as part of the interaction/inquiry.

Further, the purchase eligibility criteria in the data structure 120 may limit the particular merchants from which the consumer 114 may purchase products, in general, or specific to the products being purchased and/or category of products being purchased. For example, the policy authority 110 may impose a criteria, which requires gasoline purchases to be made from Petro Station A (in order to be an eligible transaction), even though the policy authority 110 permits the purchase of other, different products from Petro Station B.

With continued reference to FIG. 1, the consumer's communication device 116 includes a web-based eligibility application, which includes a unique app identifier or (ID). The communication device 116 is configured, by the eligibility application, to interact with the purchase eligibility server 118 to determine which, if any, purchase eligibility criteria in the data structure 120 are relevant to products to be purchased by the consumer 114.

In particular, when the consumer 114 is about to make a product purchase, for example, at the merchant 102, the consumer 114, using the communication device 116, obtains a product identifier (or ID) for the product to be purchased. The product identifier may include a UPC, SKU, or similar product ID (or a combination thereof). The consumer 114 may input the product identifier into the communication device 116 via a keyboard, touchscreen, or voice command (broadly, an input device 208). Or, the consumer 114 may use a camera or other optical scanning device (broadly, an input device 208) to scan the product identifier from a barcode, Quick Response (QR) code, or the like associated with the product. In addition, the consumer 114 may enter keywords into the communication device 116, via the eligibility application, to search the data structure 120 for the desired product information (for the product to be purchased, etc.). Alternatively, the communication device 116 and the product to be purchased may be capable of Near Field Communication (NFC) (e.g., via network interface 210), such that when the consumer 114 brings the communication device 116 into close proximity with the product, the communication device 116 reads the product identifier from the product (and/or other product information), etc.

After obtaining the product identifier from the desired product, the consumer's communication device 116, as configured by the eligibility application, transmits a request (broadly, a query) for validation of the desired product to the purchase eligibility provider 118. The request includes, for example, the product identifier and identifying information about the consumer 114 (e.g., a name, an identification number, etc.), etc. In turn, the purchase eligibility provider 118 is configured to search for the product identifier and/or the consumer 114 in the data structure 120 and any corresponding purchase eligibility criteria. Then, when the purchase eligibility provider 118 identifies relevant purchase eligibility criteria for the product and/or the consumer 114, the purchase eligibility server 118 is configured to determine if the product satisfies the one or more identified criteria. If the product satisfies the criteria, the purchase eligibility provider 118 is configured to transmit a response (e.g., a valid response, etc.) to the consumer's communication device 116 that includes a valid indicator, thereby causing the valid indicator to be displayed to the consumer 114 at the communication device 116. In this way, the consumer 114 is informed that the product is eligible for purchase (i.e., the purchase of the product is considered an eligible transaction by the policy authority 110) prior to attempting to finalize the purchase. As such, the consumer 114 can proceed with the purchase with confidence that the purchase will be covered by the policy authority 110 (e.g., by funding, by approval, by benefit, by reimbursement, etc.). Conversely, if the product does not satisfy the criteria, the purchase eligibility provider 118 is configured to transmit a response (e.g., an invalid response, etc.) to the consumer's communication device 116 that includes an invalid indicator. The consumer 114 is then permitted to proceed with the purchase, if desired, knowing that the purchase is ineligible and likely (or certainly) will not be covered by the policy authority 110.

As an example implementation of the system 100, the policy authority 110, as an employer, may provide a payment card to employee consumer 114, who frequently travels by car for business. The authority 110 may limit use of the payment card to purchases of “fuel” and “food” for the consumer 114 when he/she is traveling (i.e., as purchase eligibility criteria for the payment card and/or the consumer 114). Via the system 100, the consumer 114 can use the communication device 116 to determine (by the above interaction between the communication device 116 and the purchase eligibility provider 118) if a product at the merchant 102, for example, satisfies the “fuel” or “food” categories (i.e., the authority's purchase eligibility criteria) prior to actually making the purchase, thereby allowing the consumer 114 to make an informed purchasing decision.

In another example implementation of the system 100, the policy authority 110, as an employer, may provide a temporary payment card to employee consumer 114, which enables the consumer 114 to spend a limited, predefined amount of money for business purposes per day (i.e., as a purchase eligibility criteria for the temporary payment card and/or the consumer 114). Via the system 100, the consumer 114 can use the communication device 116 (in communication with the purchase eligibility provider 118) to determine if a product at the merchant 102, for example, is eligible for purchase based on how much of the consumer's limited spending money is remaining for the day. In this example, the purchase eligibility provider 118 is configured to maintain a spending total for the consumer 114 for the day (or other time period), and the communication device 116 is configured to obtain the price associated with the product (with or without tax, for example) as part of the product identifier. Then, either the purchase eligibility provider 118 or the communication device 116 (via the eligibility application) determines if the transaction is eligible (i.e., if sufficient spending money for the consumer 114 remains for the day).

In some embodiments (e.g., see method 300, etc.), the purchase eligibility provider 118 may also be configured to transmit individual purchase eligibility criteria (from the data structure 120) back to the consumer 114, at the communication device 116, rather than, or in addition to, making a determination of eligibility and providing a valid indicator or invalid indicator (as described above). Further, in some embodiments, the consumer's communication device 116 may store applicable purchase eligibility criteria for the consumer 114 in memory 204 of the communication device 116 (e.g., upon installation of the eligibility application, upon request by the consumer 114, when at least part of the purchase eligibility provider 118 is implemented in the communication device 116, etc.). In these embodiments, in the absence of the indicator from the purchase eligibility provider 118, the consumer's communication device 116, as configured by the eligibility application, may then determine if the particular product is eligible or not in view of the criteria received from the purchase eligibility provider 118 (as opposed to the purchase eligibility provider 118 making the determination), and generate an appropriate indicator. Conversely, the communication device 116 may display the one or more relevant purchase eligibility criteria to the consumer 114, from which the consumer is able to make a determination of eligibility. In any case, as can be appreciated, it may be beneficial for the consumer's communication device 116 to be able to determine if a particular product is eligible or not, for example, if network connection with the purchase eligibility provider 118 is not immediately available, or when communication of certain product and/or consumer data via network 112 is prohibited (e.g., for privacy reasons, etc.).

In some embodiments, the issuer 108 also operates as a purchase controller, through one or more operations of the computing device 200. In such embodiments, the policy authority 110 may provide various purchase eligibility criteria to the issuer 108. The issuer 108 (i.e., the purchase controller) is then configured, via computer executable instructions stored in memory 204 (e.g., in a similar manner to the purchase eligibility provider 118 described herein, etc.), to intercept and/or otherwise inhibit or impede transactions from the consumer 114 (and/or from other consumers) that do not satisfy the various received purchase eligibility criteria. As a result, the customer 114 is inhibited, by the issuer 108, from violating the purchase eligibility criteria established by the policy authority 110.

With further reference to FIG. 1, while one merchant 102, one acquirer 104, one payment network 106, one issuer 108, one authority 110, and one consumer 114, are illustrated in FIG. 1, it should be appreciated that any number of these parts (and their associated parts, including third parties) may be included in the system 100, or may be included as one or more parts of systems in other embodiments, consistent with the present disclosure.

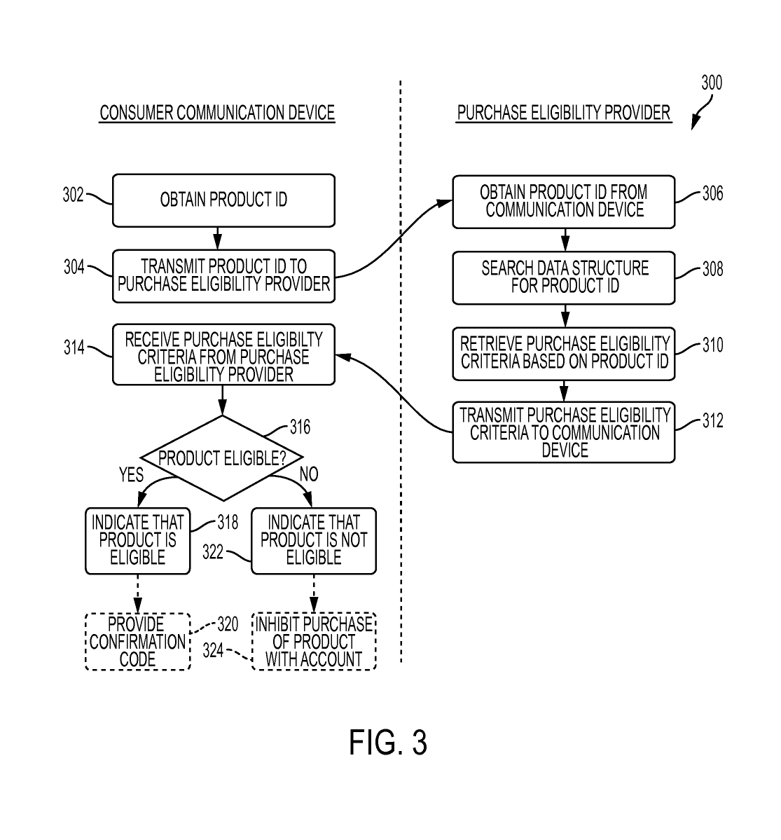

FIG. 3 illustrates an exemplary method 300 for obtaining purchase eligibility criteria for a desired product and determining if the product satisfies the criteria (and therefore is eligible for purchase by a consumer using one or more particular payment accounts). The exemplary method 300 is described as implemented in the purchase eligibility provider 118 of system 100, and in the portable communication device 116 associated with consumer 114. However, it should be understood that the method 300 is not limited to this configuration, as the method 300 may be implemented in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

In the method 300, when the consumer 114 desires to purchase a product from the merchant 102 (e.g., a target product, etc.), for example, the consumer 114 begins, at 302, by obtaining a product ID from the product (or for the product) using the communication device 116. As described above in connection with the system 100, this may include using the communication device 116, as configured by the eligibility application, to scan a barcode on the product using a camera feature of the communication device 116, or to receive a manual entry by the consumer 114 of the product ID to the communication device 116. Or, it may include using the communication device 116 in other manners, or even using other operations, to obtain the product ID. The product ID may include any information about the product, including, for example, information specific to the product, and information specific to multiple products (e.g., a product category, etc.), etc.

The communication device 116 then transmits, at 304, the obtained product ID to the purchase eligibility provider 118, for example, as part of an eligibility request. In turn, the purchase eligibility provider 118 receives the product ID via the request, at 306. The request may be transmitted to the purchase eligibility provider 118 via any suitable medium including, for example, a message through the eligibility application, electronic mail (email), short message service (SMS) text, etc.). Alternatively, the communication device 116 may access the purchase eligibility provider 118 through a website, an email server, or the like. In addition to the product ID, the request also generally includes a consumer ID specific to one or more of the consumer 114, the policy authority 110, and/or a category of the consumer 114 (e.g., a job title or level, etc.), etc. Other information beyond the product ID and a consumer ID may be further included in the request, including, without limitation, location data for the consumer 114 and/or merchant 102, a merchant ID for the merchant 102, a MCC for the merchant 102, etc.

Upon receiving the eligibility request, the purchase eligibility provider 118 searches the data structure 120 for the product ID (and/or the consumer ID), at 308. When the appropriate product ID is found, for example, relevant to the consumer 114 and/or the policy authority 110, the purchase eligibility provider 118 retrieves the corresponding purchase eligibility criteria, at 310, associated with the product ID (whether specific to the product or a category of the product). As described in connection with the system 100, the data structure 120 includes multiple product IDs (again, specific to the product and/or to a category of the product, etc.) and corresponding purchase eligibility criteria that apply to the product IDs (and, thus, to any products associated with the product IDs). The data structure 120 may also include data necessary to link the product IDs (and consumer IDs when used) to the purchase eligibility criteria. For instance, if the purchase eligibility criteria require a product to be in a particular product category, as described above, the data structure 120 may comprise a link between the product IDs and product category identifiers such that the product IDs can be placed in categories. Other data that may be stored in the data structure 120 and linked, for example, with product IDs includes product price data, merchant data, location data, and the like.

It should be appreciated that additionally, or alternatively, the purchase eligibility provider 118 may search in the data structure 120 based on any other information included in the request, or other information associated with the product ID, the consumer 114, or the policy authority 110, etc. For example, rather than searching for a product ID, the purchase eligibility provider 118 may search for the policy authority 110 and a merchant ID to retrieve purchase eligibility criteria (e.g., the policy authority 110 permits all purchases at the specific merchant, etc.).

With continued reference to FIG. 3, in method 300, the purchase eligibility provider 118 next transmits the retrieved purchase eligibility criteria to the consumer 114, at 312, via the consumer's portable communication device 116. The purchase eligibility provider 118 may transmit the criteria via any suitable medium including, for example, a message through the eligibility application message, an email, a SMS text, etc. And, in turn, the consumer's communication device 116 receives the purchase eligibility criteria from the purchase eligibility provider 118, at 314.

At 316, the communication device 116 then determines whether the product is eligible for purchase by the consumer 114, based on the received purchase eligibility criteria. As described in connection with the system 100, the purchase eligibility criteria may be made up of one or more limitations (or requirements) that must be satisfied in order for purchase of the product to be considered an eligible transaction by the policy authority 110. For example, the criteria may require that the product be in a particular category of products, etc. Or, the criteria may include a limited spending amount for the consumer 114, for example, over a time period, etc.

When the consumer's communication device 116 determines, at 316, that the product meets the retrieved purchase eligibility criteria, the communication device 116 indicates to the consumer 114, at 318, that the product is eligible for purchase. For example, the communication device 116 may display a message to the consumer 114 (including a “valid” indicator) to inform the consumer 114 of the product's eligibility, or the communication device 116 may cause a particular sound (broadly, a valid indicator) indicating the eligibility. In addition, the communication device 116 may optionally (as indicated by the dotted lines in FIG. 3) provide a confirmation code to the consumer 114, at 320, confirming that the purchase eligibility criteria are satisfied. The confirmation code may then be used by the consumer 114, as needed, as proof of purchase eligibility at a later date, etc. The confirmation code may be stored in memory 204 at the consumer's communication device 116, for example, for subsequent use by the consumer 114 in creating expense report(s) and/or otherwise showing that he/she purchased the product with the understanding that the product was eligible for purchase as defined by the policy authority's purchase eligibility criteria. Or, the communication device 116 may transmit the confirmation code to the purchase eligibility provider 118, where it is then stored (and associated with the consumer 114).

Alternatively, when the consumer's communication device 116 determines, at 316, that the product does not meet the retrieved purchase eligibility criteria, the communication device indicates, at 322, that the product is not eligible for purchase. For example, the communication device 116 may display a message to the consumer 114 (including an “invalid” indicator) indicating the ineligibility of the product, or the communication device 116 may cause a particular sound (broadly, an invalid indicator) indicating the ineligibility.

If the consumer 114 attempts to proceed with an ineligible transaction, various checks may be in place to inhibit the transaction (although such checks are not required in all embodiments). For example, the communication device 116 may, optionally (as indicated by the dotted lines in FIG. 3), inhibit the purchase of the product, at 324, using the payment account, especially where the eligibility application at the communication device 116 is part of or in communication with a payment application at the communication device 116 being used in the transaction (e.g., such as web-based transactions, transactions for which payment account information is provided via the communication device 116, etc.). Or, as described above, the issuer 108 may operate as a purchase controller to intercept and/or otherwise inhibit or impede ineligible transactions from the consumer 114. The purchase inhibition, regardless of where implemented, based on the purchase eligibility criteria, may last for a limited time, such as one hour or one day. The inhibition serves to further ensure that the consumer does not incur unexpected costs by making ineligible purchases.

In addition, the payment account associated with the consumer 114 in the method 300 may be included in an electronic wallet (e.g., PayPass® from MasterCard, Apple Pay® from Apple, PayWave® from Visa, etc.), along with other payment accounts (e.g., a personal payment account for the consumer 114, etc.). As such, in the method 300, when the consumer's communication device 116 determines, at 316, that the product meets the retrieved purchase eligibility criteria, the communication device 116 may activate and/or otherwise enable the consumer's electronic wallet (and/or the payment account therein) so that the consumer can then employ the electronic wallet and/or select the payment account for use in the transaction. However, when the consumer's communication device 116 determines, at 316, that the product does not meet the retrieved purchase eligibility criteria, the communication device 116 may deactivate the electronic wallet altogether, or potentially, activate the electronic wallet (but not the payment account) and provide an option to the consumer 114 to use one of the other payment accounts stored in the electronic wallet in the transaction (e.g., a personal payment account, etc.).

In the method 300, the determination of whether or not a product is eligible for purchase by the consumer (i.e., whether or not the product satisfies particular purchase eligibility criteria set by the authority 110) is made by the consumer's communication device 116. In other embodiments, however, the determination may be made by the purchase eligibility provider 118 (see system 100, etc.), for example, following operation 312 in method 300. In such embodiments, the purchase eligibility provider 118 may then transmit an indicator of the determination to the communication device 116, for example, indicating whether the product is eligible for purchase (e.g., a valid indicator, etc.) or not (e.g., an invalid indicator, etc.). In addition, when the primary payment account to be used by the consumer 114 is included in an electronic wallet, the purchase eligibility provider 118 may activate or otherwise enable the wallet and/or the payment account when the product is eligible for purchase, but not when the product is ineligible (e.g., when the product is ineligible, the eligibility provider 118 may activate the electronic wallet, but only allow the consumer 114 to use one of the other payment accounts in the wallet; etc.). This allocation of the operations between the consumer's communication device 116 and the purchase eligibility provider 118 may be advantageous, for example, when the communication device 116 has limited processing power and the determination of eligibility requires a complex calculation or consideration of a large number of criteria, etc.

In addition, while the communication device 116 and the purchase eligibility provider 118 are shown as performing operations separately in FIG. 3, it should be appreciated that in some embodiments the communication device 116 may include the purchase eligibility provider 118 (or at least a portion thereof). In such embodiments, the various operations of method 300 may then be considered as performed by the communication device 116 (without such bifurcation).

In some embodiments of the present disclosure, the policy authority 110 and/or the purchase eligibility provider 118 may be capable of, or configured to, grant exceptions to purchase eligibility criteria included in data structure 120 (and provided to issuer 108 as the purchase controller). The exceptions may relate to approving transactions by the consumer 114 that would otherwise be ineligible based on various purchase eligibility criteria, when certain circumstances arise/exist (e.g., emergencies, disasters, significant business opportunities, etc.). For example, when a transaction is identified as ineligible based on certain purchase eligibility criteria, the consumer 114 may provide a reason (e.g., as an option through the eligibility application at the communication device 116, etc.) to the purchase eligibility provider 118 to make exception to the certain purchase eligibility criteria. The purchase eligibility provider 118 may then request approval from the policy authority 110, or may make a determination on its own. Or, the consumer 114 may contact the policy authority 110 and provide the reason. In either case, if the reason is accepted or approved, the policy authority (or the purchase eligibility provider 118) indicates the exception to the issuer 108, so that the issuer can update the purchase eligibility criteria (e.g., relax the criteria for a time period, etc.) and the transaction may be allowed.

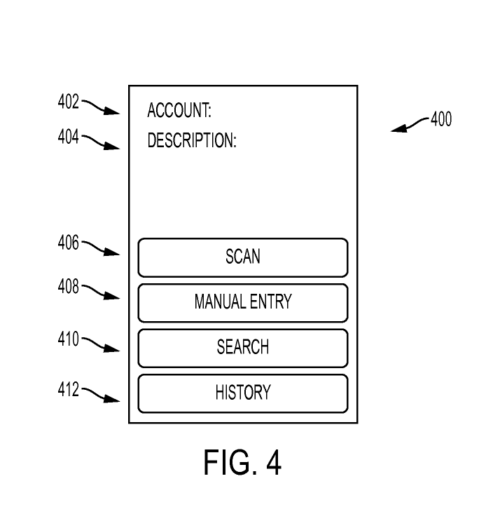

FIG. 4 illustrates an exemplary interface 400 that may be displayed at the consumer's communication device 116, via the eligibility application, for use in determining if a particular product is eligible for purchase by the consumer 114. The interface 400 generally includes an account identifier 402 and an account description 404. The account identifier 402 may include a name and/or account number that identifies the consumer 114 and/or the payment account desired to be used by the consumer in a transaction for the product. The account description 404 includes a short description of the consumer's payment account, for example, such as general limitations on products that can be purchased with the corresponding payment account (e.g., food and fuel, etc.), etc. In some embodiments, the interface 400 may also include information about the issuer 108 that issued the payment account, and/or the authority 110 that provided the payment account to the consumer 114.

The interface 400 of FIG. 4 also includes a scan button 406 and a manual entry button 408, for use in obtaining a product ID for the particular product of interest to the consumer 114 (e.g., at operation 302 of method 300, etc.). The scan button 406 can be used by the consumer 114 to scan a product ID from the product (e.g., a barcode, a QR code, a UPC, a SKU code, etc.). For example, upon pressing the scan button 406, the device 116 may activate a camera of the communication device 116 and scan in front of the device's camera immediately, or it may show a separate camera interface allowing the consumer 114 to line up the camera with the product ID before scanning. The manual entry button 408 can be used by the consumer 114 to manually enter a product ID from the product (e.g., a barcode number, a UPC number, a SKU code number, a product model number, etc.). For example, upon pressing the manual entry button 408, the communication device 116 may activate a keypad through which the consumer 114 is enabled to manually enter the product ID, or may activate a microphone through which the consumer 114 can say the product ID. In either case, once the product ID for the product is received by the communication device 116, the communication device 116 stores the product ID in memory 204, and transmits the product ID to the purchase eligibility provider 118 (e.g., at operation 304 of method 300, etc.), for example, to perform a search in the data structure 120 for corresponding purchase eligibility criteria.

The interface 400 of FIG. 4 further includes a search button 410 that enables the consumer 114 to search for a particular product by entering keywords, etc., in the event that the consumer 114 does not have access to a sufficiently unique product ID for the product. The communication device 116 may access the Internet to perform the search, or the communication device 116 may access a particular data structure of products to perform the search (e.g., the data structure 120, etc.). In either case, after performing the search, the communication device 116 may prompt the consumer 114, via the interface 400 or another interface, to view one or more search results and to choose the intended product (if it is present in the search results). A product ID for the identified product can then be transmitted to the purchase eligibility provider 118, as described above. A history button 412 is also included in the interface 400 to allow the consumer 114 to view past product searches and product ID queries. As such, through the history button 412, the consumer can view prior results, as desired, rather than re-scanning or re-entering product IDs or keywords.

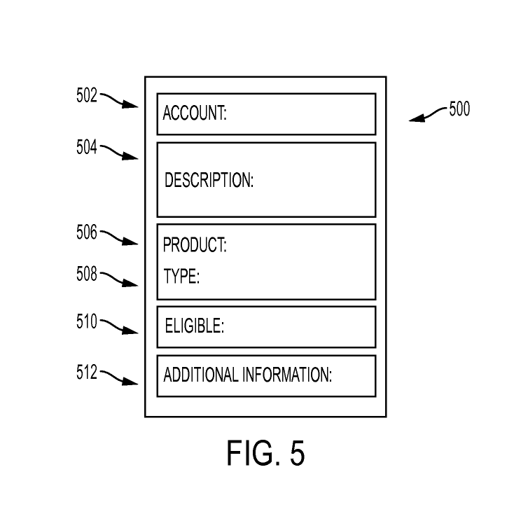

FIG. 5 illustrates an exemplary interface 500 that may be displayed at the consumer's communication device 116, via the eligibility application, following a determination of whether or not a particular product is eligible for purchase by the consumer 114 (e.g., at operations 318 and 322 of method 300, e.g., after use of interface 400 to obtain a product ID, etc.). The interface 500 generally includes an account identifier 502 and an account description 504 similar to the account identifier 402 and account description 404 of interface 400. The interface 500 also includes a product name 506 and a product type 508 for the particular product of interest to the consumer 114. The product name 506 comprises a name of the product specific enough for the consumer 114 to confirm that it matches the product queried, and may also include an image of the product for additional confirmation. The product type 508 indicates a type or classification of the product used in the determination of purchase eligibility for the product (which may help clarify to the consumer 114 why the product is eligible or ineligible for purchase).

The interface 500 of FIG. 5 also includes an eligibility indicator 510 that shows whether or not the product is eligible for purchase, after considering all applicable purchase eligibility criteria. The eligibility indicator may be a simple “Yes” or “No” or it may include a more detailed description/reason for the particular indicator addressing, for example, product types and eligibility, or it may even include a more complex comparison taking into account the consumer's “per diem,” for example, as described above. And, an additional information section 512 is provided for including information about the eligibility determination that may help further clarify the determination to the consumer 114 such as, for example, describing what requirements cause the product to be ineligible, or how much of a limited dollar amount remains in the consumer's payment account for use in purchasing the product.

While the exemplary interfaces 400 and 500 relate to a single payment account, it should be appreciated that in other embodiments similar interfaces may relate to multiple different payment accounts available to the consumer 114 (e.g., enrolled by the consumer with the purchase eligibility provider 118, etc.) and may allow the consumer 114 to select between ones of the multiple different payment accounts to query products.

In view of the above, the systems and methods herein may permit merchants or account issuers to create and maintain eligibility servers for determining eligibility of products for purchase using limited accounts. Consumers with access to limited accounts are able to access the eligibility servers to determine a product's eligibility for purchase prior to attempting to purchase the product at checkout or finalizing the purchase. In this manner, consumers can make informed decisions about their purchases using the provided product eligibility information.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) obtaining a product identifier, the product identifier indicative of at least the product and/or a product category associated with the product; (b) transmitting at least a product identifier to an authority; (c) receiving a purchase eligibility criteria associated with a product identifier; (d) displaying a valid indicator, when a product satisfies a purchase eligibility criteria, thereby permitting a consumer to purchase a product with confidence that said purchase complies with eligibility criteria defined by an authority; (e) obtaining a product eligibility query from a consumer, the product eligibility query including a product identifier indicative of at least one of the product and/or a product category of the product; (f) searching a data structure for purchase eligibility criteria associated with a consumer and/or a product identifier; and (g) sending a response to a product eligibility query to a consumer, the response comprising one or more purchase eligibility criteria associated with the consumer and/or a product identifier . . .

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in complying with purchase eligibility criteria defined by an authority, the method comprising:
obtaining, by a computing device, a product identifier, the product identifier indicative of at least a product and/or a product category associated with the product;
transmitting, by the computing device, at least the product identifier to the authority;
receiving, by the computing device, a purchase eligibility criteria associated with the product identifier;
determining, by the computing device, whether the product complies with the purchase eligibility criteria; and
displaying, at the computing device, a valid indicator, when the product satisfies the purchase eligibility criteria, thereby permitting the consumer to purchase the product confident that said purchase complies with the eligibility criteria defined by the authority for the product.

2. The computer-implemented method of claim 1, further comprising accessing an electronic wallet including at least one payment account associated with the consumer, for use by the consumer in purchasing the product, when the product satisfies the purchase eligibility criteria.

3. The computer-implemented method of claim 1, further comprising displaying, at the computing device, an invalid indicator, when the product fails to satisfy the purchase eligibility criteria.

4. The computer-implemented method of claim 1, wherein receiving the purchase eligibility criteria includes receiving, at the computing device, a valid response when the product satisfies the purchase eligibility criteria; and
wherein the valid indicator is associated with the valid response.

5. The computer-implemented method of claim 1, wherein obtaining a product identifier comprises optically scanning, by an input device of the computing device, a barcode of the product.

6. The computer-implemented method of claim 1, wherein the purchase eligibility criteria defines permission to purchase only a specific type of product.

7. The computer-implemented method of claim 1, wherein the purchase eligibility criteria defines permission to purchase the product within a predefined time period.

8. The computer-implemented method of claim 1, further comprising inhibiting the purchase of the product, when the product fails to satisfy the purchase eligibility criteria.

9. The computer-implemented method of claim 1, further comprising displaying, at the computing device, when the product satisfies the purchase eligibility criteria, a confirmation code associated with the product.

10. A computer-implemented method for use in responding to product eligibility queries with respect to purchase eligibility criteria for a product, as defined by an authority, the method comprising:
obtaining, by a computing device, a product eligibility query from a consumer for a product, the product eligibility query including a product identifier indicative of at least one of the product and/or a product category of the product;
searching, by the computing device, a data structure for purchase eligibility criteria associated with the consumer and/or the product identifier; and
sending to the consumer, by the computing device, a response to the product eligibility query, the response comprising one or more purchase eligibility criteria associated with the consumer and/or the product identifier.

11. The computer-implemented method of claim 10, further comprising determining whether the product complies with one or more purchase eligibility criteria associated with the consumer and/or the product identifier.

12. The computer-implemented method of claim 11, wherein the response further comprises a valid indicator, when the product satisfies the one or more purchase eligibility criteria.

13. The computer-implemented method of claim 11, wherein the response further comprises an invalid indicator, when the product does not satisfy the one or more purchase eligibility criteria.

14. The computer-implemented method of claim 10, wherein the purchase eligibility criteria comprise a product category and/or comprise a limited amount spent.

15. The computer-implemented method of claim 10, wherein the authority is an employer that employs the consumer.

16. The computer-implemented method of claim 10, wherein the product identifier comprises at least one of a Unique Product Code (UPC) and a Stock Keeping Unit (SKU).

17. The computer implemented method of claim 10, wherein the purchase eligibility criteria comprise a list of one or more eligible merchants.

18. A system for use in responding to product eligibility queries with respect to purchase eligibility criteria for a product, as defined by an authority, the system comprising:
a processor;
a network connection in communication with the processor;
one or more memory devices in communication with the processor and storing product identifiers, purchase eligibility criteria, and processor-executable instructions comprising instructions for:
obtaining, via the network connection, a product eligibility query from a consumer, the product eligibility query comprising a product identifier indicative of at least one of the product and/or a product category of the product;
searching a data structure stored on the one or more memory devices for purchase eligibility criteria associated with the consumer and/or the product identifier; and
transmitting, over the network connection, a response to the product eligibility query to the consumer, the response comprising one or more purchase eligibility criteria associated with the consumer and/or the product identifier.

19. The system of claim 18, further comprising:
a non-transitory, computer-readable storage media in communication with the network connection including executable instructions for complying with purchase eligibility criteria defined by an authority, which, when executed by at least one processor, cause the at least one processor to:
obtain a product identifier indicative of at least the product and/or a product category associated with the product;
transmit, over the network connection, at least the product identifier to the authority;
receive, over the network connection, purchase eligibility criteria associated with the product identifier; and
display a valid indicator when the product satisfies the purchase eligibility criteria, thereby permitting the consumer to purchase the product confident said purchase complies with eligibility criteria defined by the authority.

20. The system of claim 19, wherein the executable instructions further comprise instructions for determining whether the product complies with one or more purchase eligibility criteria associated with the consumer and/or the product identifier; and
wherein the response further comprises a valid indicator when the product satisfies the one or more purchase eligibility criteria, and an invalid indicator when the product does not satisfy the one or more purchase eligibility criteria.
